(19) United States
(12) Patent Application Publication
(10) Pub. No.: US 2026/0274199 A1
(43) Pub. Date: Sep. 17, 2026

(54) WEBBING TAKE-UP DEVICE

(71) Applicant: KABUSHIKI KAISHA TOKAI-RIKA-DENKI-SEISAKUSHO, Aichi-ken (JP)

(72) Inventors: Yuta SUZUKI, Aichi (JP); Yoshiteru SAKAGUCHI, Aichi (JP)

(73) Assignee: KABUSHIKI KAISHA TOKAI-RIKA-DENKI-SEISAKUSHO, Aichi-ken (JP)

(21) Appl. No.: 19/560,308

(22) Filed: Mar. 9, 2026

(30) Foreign Application Priority Data
Mar. 17, 2025 (JP) 2025-042758

(51) Int. Cl. B60R 22/34

(52) U.S. Cl. CPC B60R 22/34

(57) ABSTRACT

In a webbing take-up device, a moving member is moved, and due to the moving member being engaged with a rotation member, the rotation member is rotated, and a spool is rotated in a webbing take-up direction. The change mechanism changes a movement path of the moving member between a front side and a rear side. This thereby enables the movement path of the moving member to be changed.

### CROSS-REFERENCE TO RELATED APPLICATION

This application is based on and claims priority under 35 USC 119 from Japanese Patent Application No. 2025-42758 filed on Mar. 17, 2025, the disclosure of which is incorporated by reference herein.

### BACKGROUND

### Technical Field

The present invention relates to a webbing take-up device in which a moving member is moved and a spool is rotated in a take-up direction.

### Related Art

In a webbing take-up device described in Japanese Patent Application Laid-Open (JP-A) No. 2017-218093, a moving member is moved and engaged with a rotation member such that the rotation member is rotated and a spool is rotated in a take-up direction.

In such a webbing take-up device, the movement path of the moving member is fixed.

### SUMMARY

In consideration of the above circumstances, an object of the present invention is to obtain a webbing take-up device capable of changing a movement path of a moving member.

A webbing take-up device of a first aspect of the present invention includes a spool that is configured to take up webbing fitted over an occupant by being rotated in a take-up direction; a rotation member that is configured so as to be rotated such that the spool is rotated in the take-up direction; a moving member that is configured such that the rotation member is rotated by the moving member being moved and engaged with the rotation member; and a change mechanism that is configured to change a movement path of the moving member.

In the webbing take-up device of the first aspect of the present invention, the spool is rotated in the take-up direction, and the webbing fitted over the occupant is taken up on the spool. The moving member is moved, and due to being engaged with the rotation member, the rotation member is rotated, and the spool is rotated in the take-up direction.

The change mechanism changes the movement path of the moving member. This thereby enables the movement path of the moving member to be changed.

A webbing take-up device of a second aspect of the present invention is the webbing take-up device of the first aspect of the present invention, wherein when the change mechanism changes the movement path of the moving member, an engagement amount with the moving member in a rotation radial direction of the rotation member is changed.

In the webbing take-up device of the second aspect of the present invention, when the change mechanism changes the movement path of the moving member, the engagement amount with the moving member in the rotation radial direction of the rotation member is changed. This thereby enables a rotation force of the rotation member due to movement of the moving member to be changed.

A webbing take-up device of a third aspect of the present invention is the webbing take-up device of the first aspect or the second aspect of the present invention, wherein when the change mechanism changes the movement path of the moving member, an engagement amount with the moving member is changed along a rotation circumferential direction of the rotation member.

In the webbing take-up device of the third aspect of the present invention, when the change mechanism changes the movement path of the moving member, and the engagement amount with the moving member is changed along the rotation circumferential direction of the rotation member. This thereby enables the rotation force of the rotation member due to movement of the moving member to be changed.

The webbing take-up device of the fourth aspect of the present invention is the webbing take-up device of any one of the first aspect to the third aspect of the present invention, further including a path member that forms the movement path of the moving member, and a change member that is provided at the change mechanism, and that supports the path member such that the path member is moved when the change member is moved.

In the webbing take-up device of the fourth aspect of the present invention, the path member forms the movement path of the moving member, and the change member of the change mechanism supports the path member such that the path member is moved when the change member is moved. This thereby enables the movement path of the moving member to be changed.

A webbing take-up device of a fifth aspect of the present invention is the webbing take-up device of the fourth aspect of the present invention, wherein the moving member being moved moves the path member.

In the webbing take-up device of the fifth aspect of the present invention, the moving member is moved to move the path member. This thereby enables a simple configuration for moving the path member.

A webbing take-up device of a sixth aspect of the present invention is the webbing take-up device of any one of the first aspect to the fifth aspect of the present invention, wherein the movement path of the moving member is branched.

In the webbing take-up device of the sixth aspect of the present invention, the movement path of the moving member is branched. This thereby enables the movement path of the moving member to be changed appropriately.

### BRIEF DESCRIPTION OF THE DRAWINGS

Exemplary embodiments of the present invention will be described in detail based on the following figures, wherein:

FIG. 1 is a perspective view illustrating a webbing take-up device according to a first exemplary embodiment of the present invention, as viewed diagonally from the rear left;

FIG. 2 is a rear view illustrating a webbing take-up device according to the first exemplary embodiment of the present invention, as viewed from the rear;

FIG. 3A is a cross-section illustrating an overall pretensioner mechanism of a webbing take-up device according to the first exemplary embodiment of the present invention, as viewed from the left;

FIG. 3B is cross-section illustrating an enlargement of main elements of a pretensioner mechanism of a webbing take-up device according to the first exemplary embodiment of the present invention, as viewed from the left;

FIG. 4A is a cross-section illustrating a pretensioner mechanism of a webbing take-up device according to the first exemplary embodiment of the present invention, as viewed from the right;

FIG. 4B is a cross-section illustrating an enlargement of a change mechanism of a webbing take-up device according to the first exemplary embodiment of the present invention, as viewed from the right;

FIG. 5A is a cross-section illustrating a change mechanism in a pretensioner mechanism of a webbing take-up device according to the first exemplary embodiment of the present invention, as viewed from the right during actuation;

FIG. 5B is a cross-section illustrating an enlargement of a change mechanism of a webbing take-up device according to the first exemplary embodiment of the present invention, as viewed from the right during actuation;

FIG. 6 is a perspective view of a webbing take-up device according to a second exemplary embodiment of the present invention, as viewed diagonally from the left rear;

FIG. 7 is a rear view illustrating a webbing take-up device according to the second exemplary embodiment of the present invention, as viewed from the rear;

FIG. 8A is a cross-section illustrating a pretensioner mechanism of a webbing take-up device according to the second exemplary embodiment of the present invention, as viewed from the right;

FIG. 8B is a cross-section illustrating a change mechanism of a webbing take-up device according to the second exemplary embodiment of the present invention, as viewed from the rear side;

FIG. 9A is a cross-section illustrating a change mechanism in a pretensioner mechanism of a webbing take-up device according to the second exemplary embodiment of the present invention, as viewed from the right during actuation;

FIG. 9B is a cross-section illustrating a change mechanism of a webbing take-up device according to the second exemplary embodiment of the present invention, as viewed from the rear side during actuation;

FIG. 10 is a perspective view of a webbing take-up device according to a third aspect of the present invention, as viewed diagonally from the left rear;

FIG. 11 is a rear view illustrating a webbing take-up device according to the third exemplary embodiment of the present invention, as viewed from the rear;

FIG. 12 is a cross-section illustrating a pretensioner mechanism of a webbing take-up device according to the third exemplary embodiment of the present invention, as viewed from the left; and

FIG. 13 is a cross-section illustrating a change mechanism in a pretensioner mechanism of a webbing take-up device according to the third exemplary embodiment of the present invention, as viewed from the left during actuation.

### DETAILED DESCRIPTION

### First Exemplary Embodiment

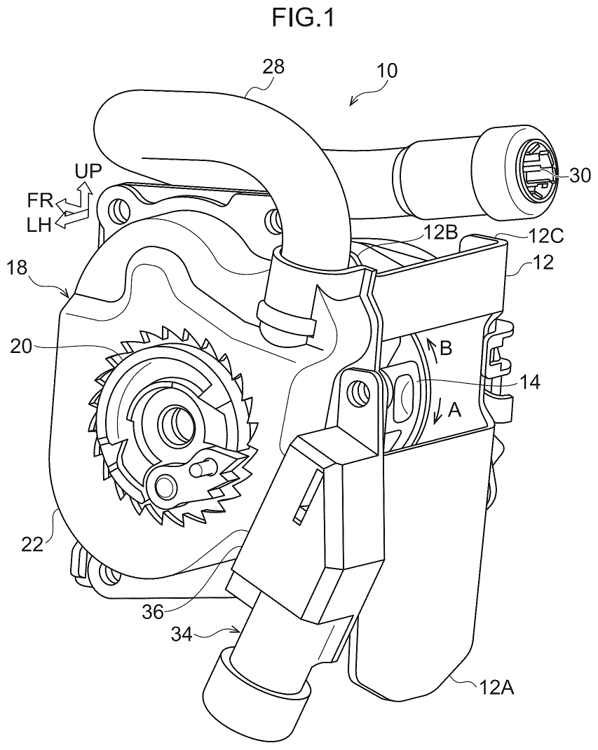

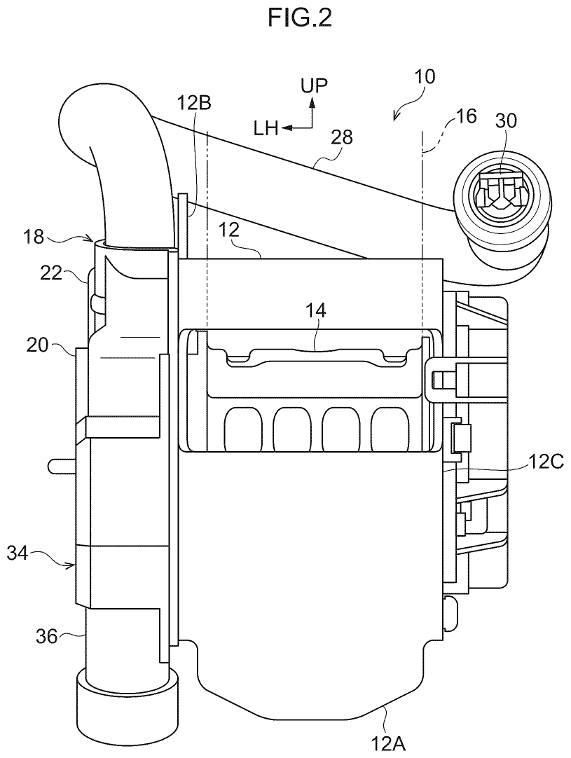

FIG. 1 is a perspective view illustrating a webbing take-up device 10 according to a first exemplary embodiment of the present invention, as viewed diagonally from the left rear, and FIG. 2 is a rear view illustrating the webbing take-up device 10, as viewed from the rear. Note that in the drawings arrow FR indicates the front of the webbing take-up device 10, arrow LH indicates the left of the webbing take-up device 10, and arrow UP indicates upward for the webbing take-up device 10.

The webbing take-up device 10 according to the present exemplary embodiment configures a seatbelt device, with the seatbelt device applied to a vehicle seat (omitted in the drawings). A sensor is provided to the seat, with the sensor detecting the build (for example, weight) of an occupant seated in the seat.

As illustrated in FIG. 1 and FIG. 2, a plate shaped frame 12 having a substantially U-shaped cross-section is provided in the webbing take-up device 10, with a back plate 12A, a leg plate 12B, and a leg plate 12C respectively provided at the rear side, left side, and right side of the frame 12.

A substantially circular cylindrical shaped spool 14 is rotatably supported between the leg plate 12B and the leg plate 12C of the frame 12, with an axial direction of the spool 14 along the left-right direction.

In the spool 14, elongated belt-shaped webbing 16 is taken up on the spool 14 from a length direction base end side thereof, with the webbing 16 being taken up on the spool 14 by the spool 14 being rotated in a take-up direction A (see FIG. 1 and the like), and also the spool 14 being rotated in a pull-out direction B (see FIG. 1 and the like) by the webbing 16 being pulled out from the spool 14. The webbing 16 is pulled upward from the spool 14 and fitted over an occupant seated on the seat.

A pretensioner mechanism 18 is provided at the left side of the frame 12.

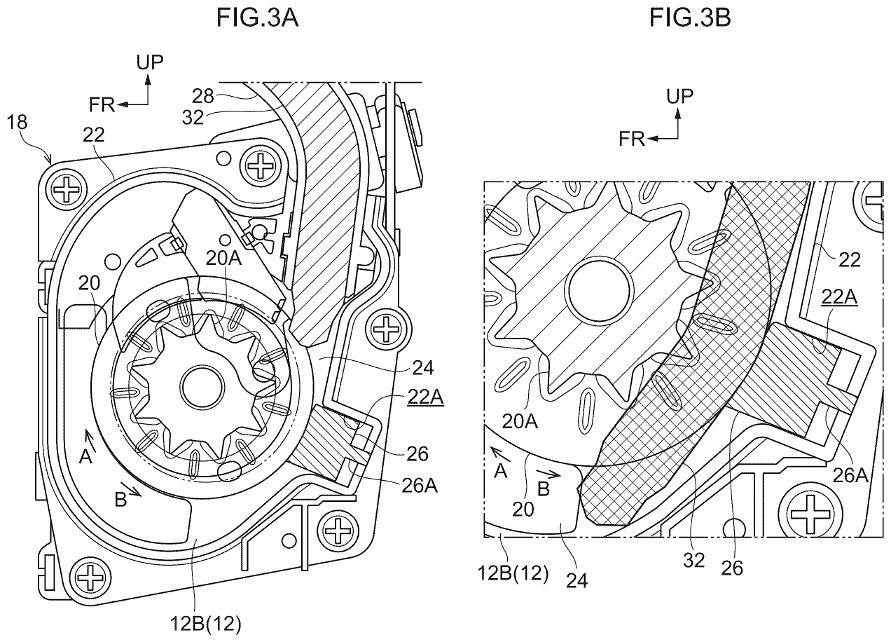

A metal rotation member 20 having a substantially circular pillar shape (see FIG. 3A) is provided to the pretensioner mechanism 18, with the rotation member 20 arranged coaxially at the left side of the spool 14 and also coupled so as to rotate as a single body with the spool 14. Plural substantially triangular pillar shaped engagement teeth 20A serving as an engaging section are provided as a single body at the outer periphery of an axial direction intermediate portion of the rotation member 20, with the plural engagement teeth 20A arranged at even intervals along the circumferential direction of the rotation member 20. The engagement teeth 20A project out toward the radial direction outside of the rotation member 20, with the engagement teeth 20A having a dimension in the rotation member 20 circumferential direction that gets smaller on progression toward the radial direction outside of the rotation member 20. The two axial direction end portions of the rotation member 20 are coaxial and have a greater diameter, with the engagement teeth 20A arranged between the two axial direction end portions of the rotation member 20.

A metal cover plate 22 having a substantially cuboidal box shape and serving as a path body is fixed to a left side of the frame 12, with the cover plate 22 inside open toward the right side. Moreover, in the front-rear direction, front-side portions of a lower wall and an upper wall of the cover plate 22 are curved so as to have a concave shape on the outer peripheral side of the cover plate 22. A substantially cuboidal shaped placement recess 22A is formed at a lower portion of a rear wall of the cover plate 22, with a front side of the placement recess 22A open to the cover plate 22 inside, and with the left side and the right side thereof respectively closed off by a bottom wall (left wall) of the cover plate 22 and the leg plate 12B of the frame 12. A movement path 24 is formed from a rear portion of the cover plate 22 inside, via a lower portion and front portion, to an upper portion thereof, with side walls (excluding at a rear wall (the placement recess 22A), the lower wall, and the upper wall) of the cover plate 22, forming the movement path 24.

A metal guide 26, having a substantially cuboidal shape and serving as a path member, is arranged at the inside of the placement recess 22A, the guide 26 is fitted to the inside of the placement recess 22A, with a front face of the guide 26 configuring a rear face of the cover plate 22 inside. A substantially rectangular pillar shaped movement pillar 26A is integrally provided to the rear face of the guide 26, with the movement pillar 26A passing through and fitting to a bottom wall (rear wall) of the placement recess 22A. The guide 26 is arranged at a front side position, and is also able to move to the rear side, as described later, with the rearward movement of the guide 26 restricted. The front face of the guide 26 forms the movement path 24 of the cover plate 22 inside at a rear side of the rear portion of the cover plate 22 inside.

A metal cylinder 28 having a substantially circular cylindrical shape and serving as a guide body is arranged at an upper side of the frame 12, with the cylinder 28 being bent at plural locations on axial direction intermediate portions thereof. An axial direction distal end portion of the cylinder 28 extends downward and is fixed between a rear portion of the leg plate 12B of the frame 12 and a rear portion of the cover plate 22, with the inside of the axial direction distal end portion of the cylinder 28 opening downward at a portion on the upper side and rear side of the cover plate 22 inside.

A micro gas generator (MGG) 30 serving as a moving device is inserted into and fixed to the inside of an axial direction base end portion of the cylinder 28, and when the MGG 30 has been actuated, high pressure gas is generated instantaneously by the MGG 30 and supplied into the cylinder 28.

A moving member 32 (see FIG. 3A) having an elongated substantially circular pillar shape is arranged inside the cylinder 28 further to the axial direction distal end side than the MGG 30, with the moving member 32 being made from resin and flexible, and also substantially fitting the cylinder 28 inside.

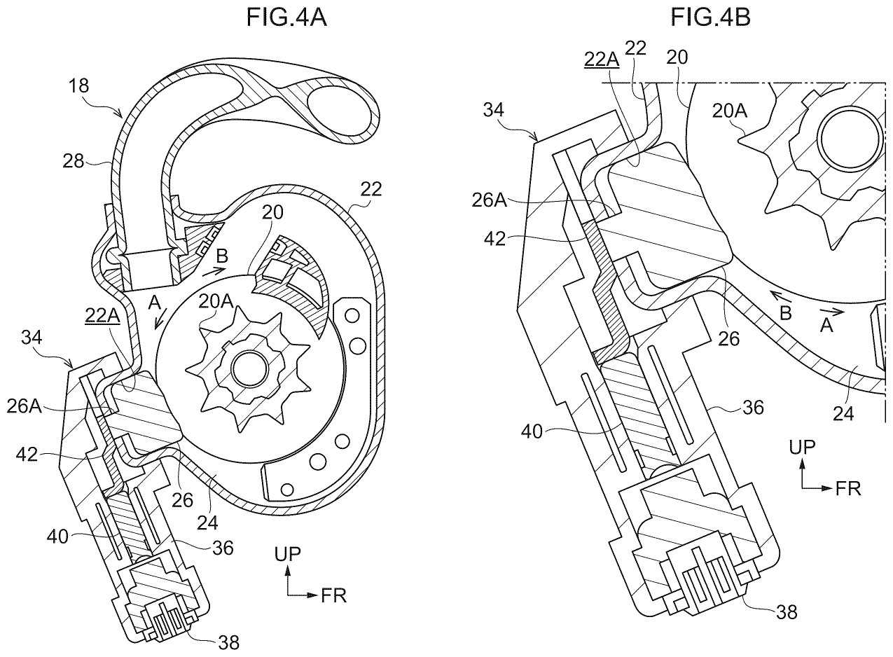

At a left side of the frame 12, a change mechanism 34 (see FIG. 4A and FIG. 4B) is arranged at a rear side of the cover plate 22.

A metal change cylinder 36 having a tubular shape is provided to the change mechanism 34, with the change cylinder 36 fixed to a left side of the leg plate 12B of the frame 12 and having an axial direction substantially along the up-down direction. Inside a lower end portion of the change cylinder 36 (axial direction base end portion), a change MGG 38 (change micro gas generator) serving as a changing device is inserted and fixed, and when the change MGG 38 has been actuated, high pressure gas is generated instantaneously by the change MGG 38 and supplied into the change cylinder 36.

A metal piston 40 having a substantially rectangular pillar shape is fitted inside the cylinder 28 further to the upper side (axial direction distal end side) than the change MGG 38, with the piston 40 being able to move upward.

Inside the cylinder 28, a substantially rectangular plate shaped change member 42 that is made from metal (and particularly from a steel) is inserted further toward the upper side than the piston 40, with movement of the change member 42 toward the rear side being restricted. A lower end portion of the change member 42 is arranged substantially perpendicular to the up-down direction and is arranged at the upper side of the piston 40, with the change member 42 able to move a specific distance upward. The change member 42 is arranged with the upper portion and the lower portion substantially perpendicular to the front-rear direction, is bent between the upper portion and the lower portion, with the upper portion of the change member 42 arranged at the front side with respect to the lower portion of the change member 42. At an upper portion inside of the cylinder 28, the placement recess 22A peripheral wall of the cover plate 22 is inserted inside from the front side, and a movement pillar 26A of the guide 26 in the placement recess 22A is abutted from the front side against an upper portion of the change member 42. Rearward movement of the guide 26 is accordingly restricted.

Next, description follows regarding operation of the present exemplary embodiment.

In the webbing take-up device 10 configured as described above, during a vehicle collision (when a collision is detected), in the pretensioner mechanism 18, the MGG 30 is actuated, and due to high pressure gas being supplied instantaneously by the MGG 30 to inside the cylinder 28, the moving member 32 inside the cylinder 28 is moved by the pressure of this gas toward the axial direction distal end side of the cylinder 28 and extends downward from the axial direction distal end of the cylinder 28. Then, due to the moving member 32 being moved along the side walls of the cover plate 22 at the cover plate 22 inside, the moving member 32 is moved downward at a rear portion of the cover plate 22 inside, is moved forward at a lower portion of the cover plate 22 inside, is moved upward at front portion of the cover plate 22 inside, and is moved rearward at an upper portion of the cover plate 22 inside, and the movement path 24 of the cover plate 22 inside is moved.

When the moving member 32 is moved downward at a rear portion of the cover plate 22 inside, the moving member 32 passes downward between a rear portion of the axial direction intermediate portion of the rotation member 20 and the guide 26 at the cover plate 22 rear wall, the engagement teeth 20A on the rear portion of the rotation member 20 engage (bite into) the moving member 32 (see FIG. 3B), the rotation member 20 is rotated in the take-up direction A by the moving member 32, and the spool 14 is rotated in the take-up direction A as a single body with the rotation member 20. This means that the webbing 16 is taken up on the spool 14 and the restraining force on the occupant due to the webbing 16 is increased. Note that the moving member 32 is not engaged with the engagement teeth 20A at positions after passing between the rear portion of the axial direction intermediate portion of the rotation member 20 and the guide 26.

During a vehicle collision (when a collision is detected) for cases in which the seat sensor has detected that the occupant has a large build, by not actuating the change MGG 38 in the change mechanism 34, the movement pillar 26A of the guide 26 at the cover plate 22 rear wall is abutted against the upper portion of the change member 42 such that rearward movement of the guide 26 is restricted (see FIG. 4A and FIG. 4B). The guide 26 is accordingly arranged at the front side position, and due to the distance to the engagement teeth 20A at the rear portion of the rotation member 20 being small, an engagement amount (piercing amount, catching amount) of the engagement teeth 20A into the moving member 32 is large. This means that the rotation force in the take-up direction A on the rotation member 20 and the spool 14 from movement of the moving member 32 is large, and due to the take-up force of the webbing 16 onto the spool 14 being large (high power), the restraining force from the webbing 16 can be made appropriate for the occupant of large build.

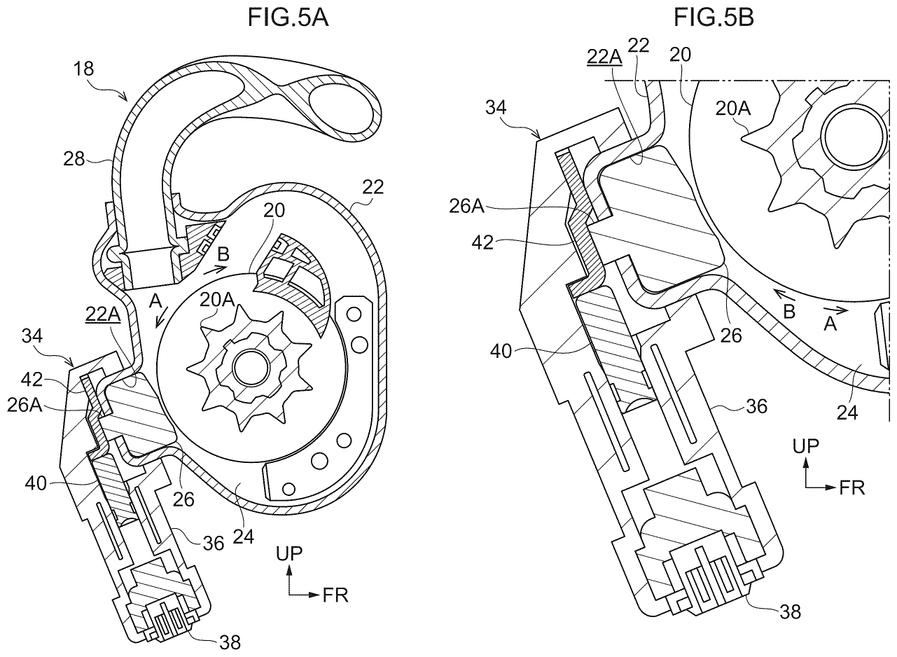

During a vehicle collision (when a collision is detected) for cases in which the seat sensor has detected that the occupant has a small build, the change MGG 38 in the change mechanism 34 is actuated, and due to the change MGG 38 instantaneously supplying high pressure gas into the change cylinder 36, the piston 40 is moved upward by the pressure of this gas inside the change cylinder 36, and the change member 42 is moved upward by the piston 40 (see FIG. 5A and FIG. 5B). The guide 26 is accordingly moved to the rear side by the moving member 32, the movement pillar 26A of the guide 26 is abutted against the lower portion of the change member 42, and due to the guide 26 being arranged at the rear side position, the distance of the guide 26 to the engagement teeth 20A of the rear portion of the rotation member 20 is large, and the engagement amount (piercing amount, catching amount) of the engagement teeth 20A into the moving member 32 is small. This means that the rotation force in the take-up direction A on the rotation member 20 and the spool 14 from movement of the moving member 32 is small, and due to the take-up force of the webbing 16 on the spool 14 being small (de-powered), the restraining force from the webbing 16 can be made appropriate for the occupant of small build.

In the change mechanism 34, the guide 26 is arranged at the front side position and the movement path 24 of the moving member 32 at the rear portion of the cover plate 22 inside is configured at the front side by not actuating the change MGG 38, however, the guide 26 is arranged at the rear side position and the movement path 24 of the moving member 32 in the rear portion of the cover plate 22 inside is configured at the rear side by actuating the change MGG 38. This thereby enables the movement path 24 of the moving member 32 to be changed at the rear portion of the cover plate 22 inside.

Furthermore, the change mechanism 34 changes the movement path 24 of the moving member 32 such that the engagement amount in the rotation radial direction of the rotation member 20 (the engagement teeth 20A) with the moving member 32 is also changed. This thereby enables the rotation force of the rotation member 20 due to movement of the moving member 32 to be changed, and enables the take-up force of the webbing 16 onto the spool 14 to be changed (enables switching thereof). Moreover, due to only the movement path 24 of the moving member 32 being changed, there is no need for additional component or configuration for the rotation member 20 or for shaft bearing of the rotation member 20.

Moreover, in the change mechanism 34, the movement pillar 26A of the guide 26 is abutted against an upper portion of the change member 42 and the guide 26 is arranged at the front side position and, by the change member 42 being moved upward, the movement pillar 26A of the guide 26 is able to be abutted against the lower portion of the change member 42, and the guide 26 is moved to the rear side position. This thereby enables the movement path 24 of the moving member 32 to be changed with a simple configuration, and enables the change mechanism 34 to be made more compact. Moreover, the change MGG 38 merely needs to move the change member 42. This thereby enables the output of the change MGG 38 to be small, and enables a reduction in cost of the change MGG 38.

Furthermore, by the moving member 32 being moved, the moving member 32 presses the guide 26 and moves the guide 26. This means that there is no need for a separate device to move the guide 26, and configuration to move the guide 26 can be simplified.

### Second Exemplary Embodiment

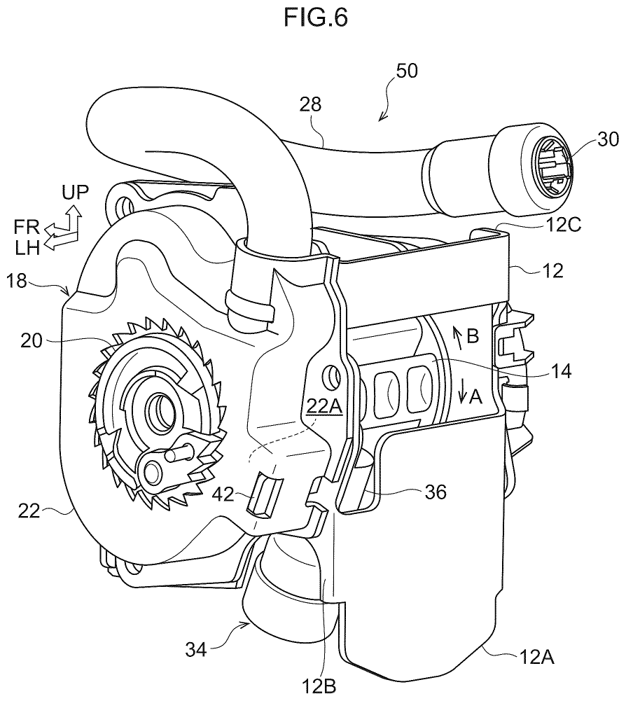

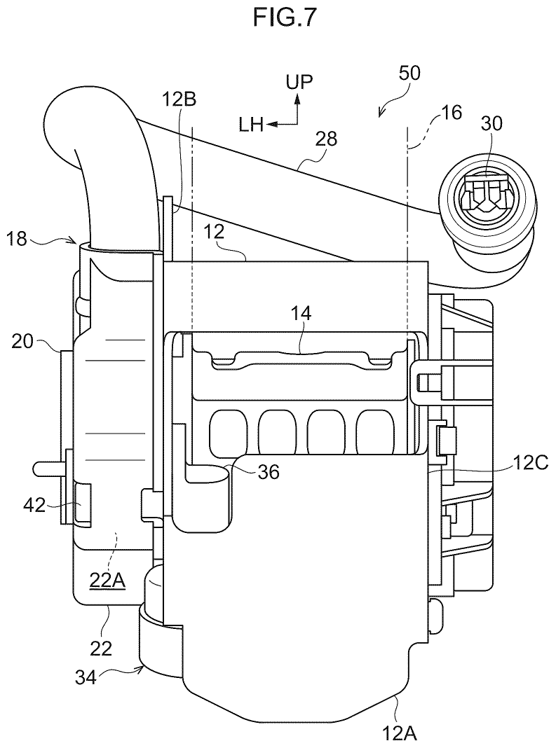

FIG. 6 is a perspective view of a webbing take-up device 50 according to a second exemplary embodiment of the present invention, as viewed diagonally from the left rear, and FIG. 7 is a rear view of the webbing take-up device 50, as viewed from the rear.

The webbing take-up device 50 according to the present exemplary embodiment is configured substantially the same as the first exemplary embodiment, but differs in the following points.

As illustrated in FIG. 6 and FIG. 7, in a pretensioner mechanism 18 of the webbing take-up device 50 according to the present exemplary embodiment, a change mechanism 34 is arranged at a position at the right side of the leg plate 12B of the frame 12, at a position at the rear side of the cover plate 22, with the change cylinder 36 of the change mechanism 34 fixed to the right side of the leg plate 12B of the frame 12.

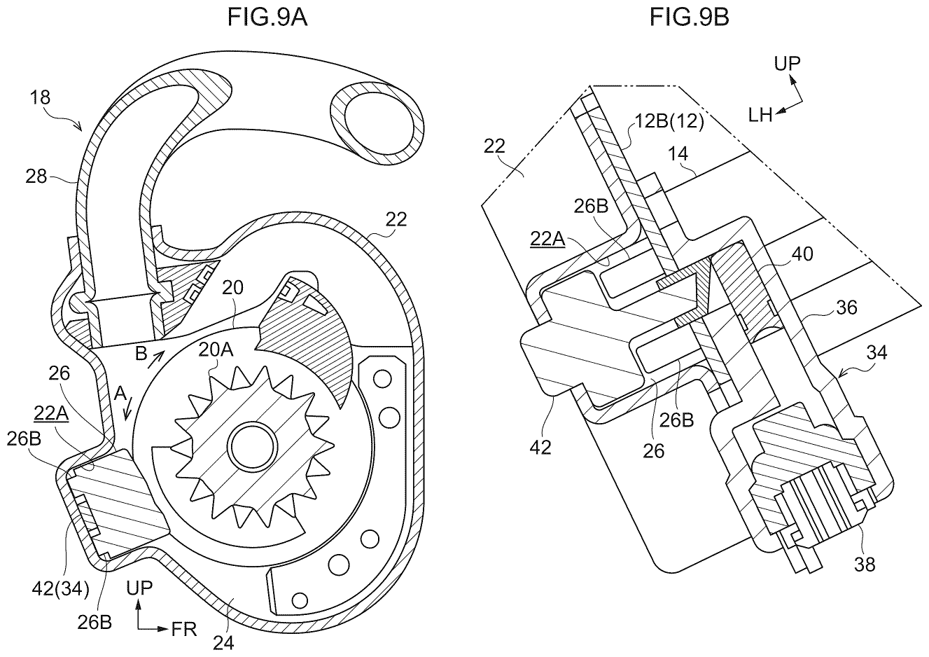

Instead of the movement pillar 26A, a pair of rectangular plate shaped movement plates 26B (see FIG. 9B) are provided as a single body on the rear face of the guide 26 inside the placement recess 22A of the cover plate 22. The movement plates 26B are respectively arranged at an upper portion and a lower portion of the right side section of the rear face of the guide 26, with the movement plates 26B projecting out rearward and extending along the left-right direction.

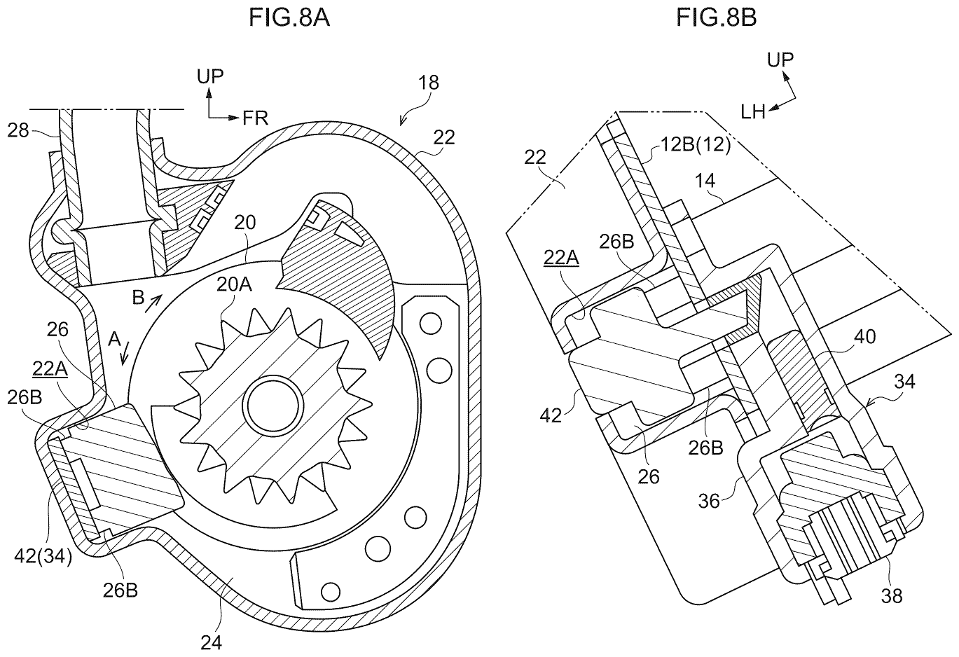

The change member 42 of the change mechanism 34 (see FIG. 8A and FIG. 8B) is configured by a substantially cross-shaped profile plate shape, with an intermediate portion (left-right direction intermediate portion) of the change member 42 enlarged at both substantially up-down direction sides. The intermediate portion of the change member 42 is fitted inside the placement recess 22A of the cover plate 22 in the substantially up-down direction, with the change member 42 arranged at a position on the right side. A left portion of the change member 42 passes through and is fitted to a left wall of the placement recess 22A, and the change member 42 is configured so as to be able to move leftward. The right portion of the change member 42 passes through the leg plate 12B of the frame 12 and the peripheral wall of the change cylinder 36, and the right end face of the change member 42 is arranged inside the change cylinder 36. The right end face of the change member 42 is arranged at the upper side of the piston 40 inside the change cylinder 36, and the right end face of the change member 42 is inclined in a direction toward the left side on progression downward. The pair of movement plates 26B of the guide 26 rear face are abutted from the front side against the intermediate portion of the change member 42, with movement of the guide 26 toward the rear side restricted thereby and the guide 26 arranged at a front side position.

During a vehicle collision (when a collision is detected) for cases in which the seat sensor has detected that the occupant has a large build, by not actuating the change MGG 38 in the change mechanism 34, the pair of movement plates 26B of the guide 26 at the cover plate 22 rear wall continue to be abutted against the intermediate portion of the change member 42, and rearward movement of the guide 26 is restricted (see FIG. 8A and FIG. 8B). The guide 26 is accordingly arranged at the front side position, and the distance to the engagement teeth 20A of the rotation member 20 rear portion is small, such that the engagement amount (piercing amount, catching amount) of the engagement teeth 20A into the moving member 32 is large. The rotation force in the take-up direction A on the rotation member 20 and the spool 14 from movement of the moving member 32 is accordingly large, and due to the take-up force of the webbing 16 onto the spool 14 being large (high power), the restraining force can be made appropriate for the occupant of large build from the webbing 16.

During a vehicle collision (when a collision is detected) for cases in which the seat sensor has detected that the occupant has a small build, the change MGG 38 in the change mechanism 34 is actuated, and due to the change MGG 38 instantaneously supplying high pressure gas into the change cylinder 36, the piston 40 is moved upward by the pressure of this gas inside the change cylinder 36, the change member 42 is moved leftward by the right end face of the change member 42 being abutted by the piston 40 (see FIG. 9A and FIG. 9B). This means that the intermediate portion of the change member 42 is moved to the left side of the pair of movement plates 26B of the guide 26, and also the guide 26 is moved rearward while the right portion of the change member 42 is being inserted between the pair of movement plates 26B by the moving member 32, and the guide 26 is arranged at the rear side position, such that the distance of the guide 26 to the engagement teeth 20A of the rotation member 20 rear portion is large, and the engagement amount (piercing amount, catching amount) of the engagement teeth 20A into the moving member 32 is small. This means that the rotation force in the take-up direction A on the rotation member 20 and the spool 14 from movement of the moving member 32 is small, and due to the take-up force of the webbing 16 on the spool 14 being small (de-powered), the restraining force from the webbing 16 can be made appropriate for the occupant of small build.

Similar operation and advantageous effects to those of the first exemplary embodiment can be exhibited by the present exemplary embodiment too.

In particular, in the change mechanism 34, the guide 26 is arranged at the front side position when the pair of movement plates 26B of the guide 26 are abutted against the intermediate portion of the change member 42, and the guide 26 is moved to the rear side position by the change member 42 being moved to the left side and the intermediate portion of the change member 42 being moved to the left side of the pair of movement plates 26B and the right portion of the change member 42 being inserted between the pair of movement plates 26B. This thereby enables the movement path 24 of the moving member 32 to be changed using a simple configuration, and enables the change mechanism 34 to be made compact.

Note that in the first exemplary embodiment and the second exemplary embodiment, the change MGG 38 may be actuated after the MGG 30 has been actuated. This thereby enables the take-up force of the webbing 16 on the spool 14 to be changed from a large state to a small state.

### Third Exemplary Embodiment

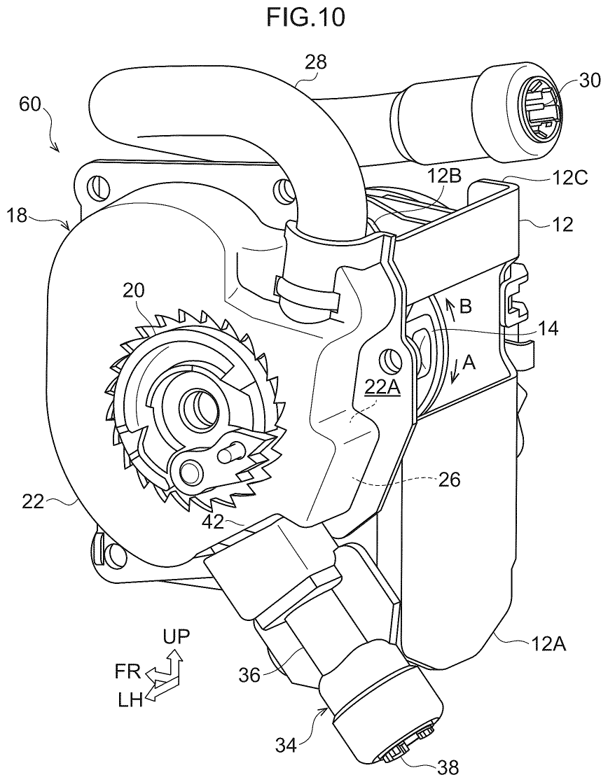

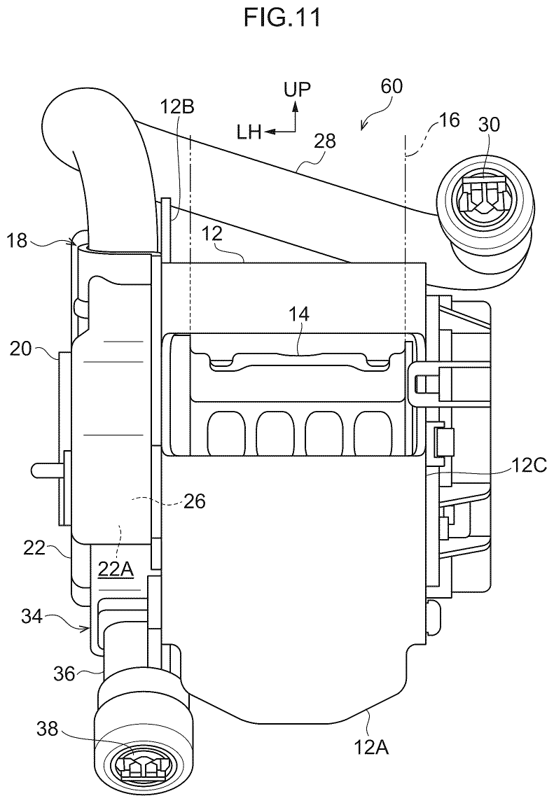

In FIG. 10, a webbing take-up device 60 according to the third exemplary embodiment of the present invention is illustrated in a perspective view, as viewed diagonally from the left rear, and in FIG. 11, the webbing take-up device 60 is illustrated in rear view, as viewed from the rear.

The webbing take-up device 60 according to the present exemplary embodiment is configured substantially the same as the first exemplary embodiment, but differs in the following points.

As illustrated in FIG. 10 and FIG. 11, in the pretensioner mechanism 18 of the webbing take-up device 60 according to the present exemplary embodiment, the change mechanism 34 is arranged at a left side of the frame 12 and at a lower side of the cover plate 22.

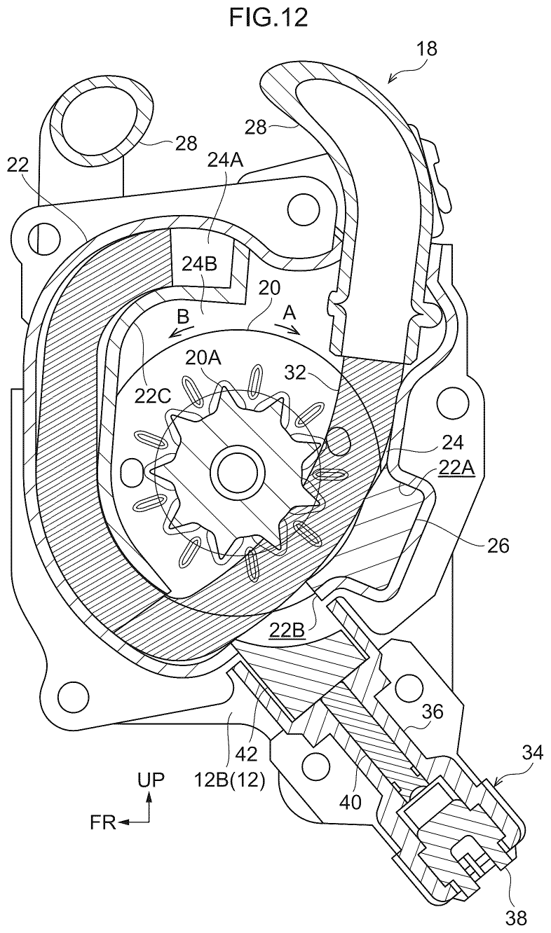

The guide 26 is fixed to the inside the placement recess 22A of the cover plate 22, and the guide 26 is arranged at the front side position of the first exemplary embodiment (see FIG. 12). A rectangular shaped changeover 22B is formed piercing through the lower wall of the cover plate 22, and the changeover 22B is arranged at the lower side of the guide 26.

A branch plate 22C having an elongated plate shape and serving as a branch section is arranged from a front portion to an upper portion of the cover plate 22 inside, with the branch plate 22C configured as a single body with the bottom wall of the cover plate 22, and also extending along an upper wall from the front wall of the cover plate 22. The upper side end portion of the branch plate 22C extends upward, and the upper side end portion of the branch plate 22C is configured as a single body with the upper wall of the cover plate 22. This means that the movement path 24 from a front portion of the cover plate 22 inside to the upper portion is branched into an outside path 24A at the outer peripheral side of the branch plate 22C of the cover plate 22, and an inner path 24B at the inner peripheral side of the branch plate 22C of the cover plate 22. Moreover, the bend angle of the branch plate 22C (the inner path 24B) between the front portion and the upper portion of the cover plate 22 inside is large (for example, configured as substantially 90°).

In the change mechanism 34, the upper portion at the inside of the change cylinder 36 is open substantially upward, and the upper portion at the inside of the change cylinder 36 opposes the changeover 22B of the cover plate 22. The change member 42 having a substantially cuboidal shape and serving as a path member is fitted inside an upper portion of the change cylinder 36, and a piston 40 is fixed to a lower face of the change member 42 inside the cylinder 28. The change member 42 is arranged further outside than the inner peripheral face of the cover plate 22, and the upper face of the change member 42 is curved in the front-rear direction so as to have a concave profile on top.

During a vehicle collision (when a collision is detected) for cases in which the seat sensor has detected that the occupant has a large build, by not actuating the change MGG 38 in the change mechanism 34, the change member 42 is arranged further outside than the inner peripheral face of the cover plate 22 (see FIG. 12). Due to the moving member 32 accordingly not being engaged with the engagement teeth 20A of the rotation member 20 while moving to the upper portion along a side wall of the cover plate 22 via the lower portion and the front portion of the cover plate 22 inside, the amount of the moving member 32 that engages with the engagement teeth 20A is made small in the rotation member 20 (the engagement teeth 20A) rotation circumferential direction, and movement resistance from the engagement of the moving member 32 with the engagement teeth 20A is made small. The rotation force in the take-up direction A of the rotation member 20 and the spool 14 due to movement of the moving member 32 is accordingly large, and due to the take-up force of the webbing 16 on the spool 14 being large (high power), the restraining force from the webbing 16 can be made appropriate for the occupant of large build.

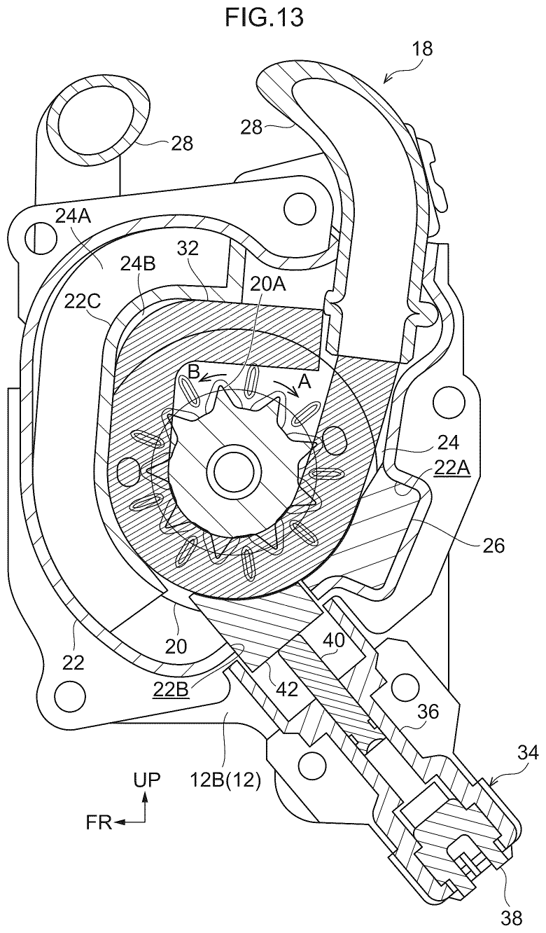

During a vehicle collision (when a collision is detected) for cases in which the seat sensor has detected that the occupant has a small build, the change MGG 38 in the change mechanism 34 is actuated, and due to the change MGG 38 instantaneously supplying high pressure gas into the change cylinder 36, the piston 40 is moved upward by the pressure of this gas inside the change cylinder 36, and the change member 42 is moved upward as a single body with the piston 40 (see FIG. 13). This means that the change member 42 is projected out into the lower portion of the cover plate 22 inside through the changeover 22B of the cover plate 22, and the moving member 32 is moved from the lower portion of the cover plate 22 inside to the upper portion via the front portion by moving along the upper face of the change member 42 and the inside face of the branch plate 22C at the cover plate 22 inside, and the moving member 32 engages with the engagement teeth 20A of the rotation member 20 from the lower portion of the cover plate 22 inside to the front portion. The engagement amount of the moving member 32 with the engagement teeth 20A in the rotation circumferential direction of the rotation member 20 (the engagement teeth 20A) is accordingly made large, and the movement resistance due to the engagement of the moving member 32 with the engagement teeth 20A is made large. This means that the rotation force in the take-up direction A of the rotation member 20 and the spool 14 due to movement of the moving member 32 is made small, the take-up force of the webbing 16 on the spool 14 is made small (de-powered), and the restraining force from the webbing 16 can be made appropriate for the occupant of small build.

In this case, in the change mechanism 34, when the change MGG 38 is not actuated, the change member 42 is arranged further to the outside than the inner peripheral face of the cover plate 22, and the movement path 24 of the moving member 32 from a lower portion of the cover plate 22 inside via the front portion to the upper portion is configured at the outer peripheral side of the cover plate 22 (includes the outside path 24A). Also, when the change MGG 38 is actuated, the change member 42 is projected out into the lower portion of the cover plate 22 inside, and the movement path 24 of the moving member 32 from a lower portion of the cover plate 22 inside via a front portion to an upper portion is configured at the inner peripheral side of the cover plate 22 (includes the inner path 24B). This accordingly enables the movement path 24 of the moving member 32 from the lower portion of the cover plate 22 inside via the front portion to the upper portion to be changed.

Furthermore, the change mechanism 34 changes the movement path 24 of the moving member 32, and the engagement amount with the moving member 32 in the rotation member 20 (the engagement teeth 20A) rotation circumferential direction is changed. This thereby enables the rotational force of the rotation member 20 due to movement of the moving member 32 to be changed, and enables the take-up force of the webbing 16 on the spool 14 to be changed (enables switching thereof). Moreover, due to merely changing the movement path 24 of the moving member 32, there is no need for additional components or configuration for the rotation member 20 or for shaft bearing of the rotation member 20.

Moreover, in the change mechanism 34, the change member 42 is arranged further to the outside than the inner peripheral face of the cover plate 22, and the change member 42 is projected out into the lower portion of the cover plate 22 inside by the change member 42 being moved upward. This thereby enables the movement path 24 of the moving member 32 to be changed with a simple configuration, and enables the change mechanism 34 to be made more compact. Moreover, the change MGG 38 only needs to move the change member 42. This thereby enables the output of the change MGG 38 to be small, and enables the cost of the change MGG 38 to be reduced.

Furthermore, the movement path 24 of the moving member 32 from the front portion of the cover plate 22 inside to the upper portion is branched by the branch plate 22C at the cover plate 22 inside, into the outside path 24A at the outer peripheral side of the cover plate 22 and the inner path 24B at the inner peripheral side of the cover plate 22. This thereby enables the movement path 24 of the moving member 32 from the front portion of the cover plate 22 inside to the upper portion to be changed appropriately.

Moreover, the bend angle of the branch plate 22C (the inner path 24B) between the front portion and the upper portion of the cover plate 22 inside is large. This means that when the moving member 32 is moved along the inner path 24B between the front portion and the upper portion of the cover plate 22 inside, the moving member 32 is bent greatly by the branch plate 22C, making the movement resistance on the moving member 32 from the branch plate 22C large. The rotation force in the take-up direction A of the rotation member 20 and the spool 14 due to movement of the moving member 32 is accordingly made even smaller, the take-up force of the webbing 16 on the spool 14 is accordingly even smaller, and the restraining force from the webbing 16 can be made even more appropriate for the occupant of small build.

What is claimed is:

1. A webbing take-up device comprising:
a spool that is configured to take up webbing fitted over an occupant by being rotated in a take-up direction;
a rotation member that is configured so as to be rotated such that the spool is rotated in the take-up direction;
a moving member that is configured such that the rotation member is rotated by the moving member being moved and engaged with the rotation member; and
a change mechanism that is configured to change a movement path of the moving member.

2. The webbing take-up device of claim 1, wherein, when the change mechanism changes the movement path of the moving member, an engagement amount with the moving member in a rotation radial direction of the rotation member is changed.

3. The webbing take-up device of claim 1, wherein, when the change mechanism changes the movement path of the moving member, an engagement amount with the moving member is changed along a rotation circumferential direction of the rotation member.

4. The webbing take-up device of claim 1, further comprising:
a path member that forms the movement path of the moving member; and
a change member that is provided at the change mechanism, and that supports the path member such that the path member is moved when the change member is moved.

5. The webbing take-up device of claim 4, wherein the moving member being moved moves the path member.

6. The webbing take-up device of claim 1, wherein the movement path of the moving member is branched.

7. The webbing take-up device of claim 1, wherein the change mechanism is configured to change the movement path of the moving member partway through the moving member being moved.

8. The webbing take-up device of claim 1, wherein the change mechanism is configured to change the movement path of the moving member such that a bending amount of the moving member is changed.
